(19) United States
(12) Patent Application Publication
(10) Pub. No.: US 2008/0150755 A1
(43) Pub. Date: Jun. 26, 2008

(54) Emergency Vehicle Indicator

(76) Inventors: Alice Jane Van Zandt, Shelby Township, MI (US); Thomas Van Zandt, Santa Clara, CA (US)

Correspondence Address: Thomas Van Zandt, 5255 Stevens Creek Blvd., #299, Santa Clara, CA, 95051, US

(21) Appl. No.: 11/839,033

(22) Filed: Aug. 15, 2007

Related U.S. Application Data
(60) Provisional application No. 60/865,971, filed on Nov. 15, 2006.

(51) Int. Cl. G08G 1/00

(52) U.S. Cl. 340/902

(57) ABSTRACT

A method and system for determining and displaying the position and velocity of an emergency vehicle relative to a user. For one embodiment of the invention, audio information from an emergency vehicle is received at a directional microphone. The position and velocity of the emergency vehicle are determined based upon the received audio information. The position and velocity of the emergency vehicle is input to a display device and the position and velocity of the emergency vehicle is displayed. For one embodiment of the invention, upon detection of siren frequencies of emergency vehicles, the audio system of the vehicle is interrupted to allow the vehicle operator to hear the siren.

### CLAIM OF PRIORITY

This application is related to, and hereby claims the benefit of provisional application No. 60/865,971 entitled “Emergency Vehicle Indicator”, which was filed Oct. 15, 2006

### FIELD

Embodiments of the invention relate generally to the field of directional indicators for sounds and more specifically to devices for indicating the location and direction and speed of a siren.

### BACKGROUND

Loud music played while driving a vehicle has been a source of distraction for motorists since the first radios were installed. When a motorist is listening to music or other audio content at a high volume it is less likely the motorist will hear the siren of an emergency vehicle. The increasing efforts of automobile manufacturers to insulate the interior of automobiles from unwanted noises has added considerably to this problem.

There have been numerous suggestions in the art for addressing this problem. Each has its own disadvantages. One such scheme is to provide a microphone on the exterior of the automobile which will activate a visual indicator within the automobile. This scheme simply notifies the motorist of the presence of an emergency vehicle. Another scheme provides a synthesized voice indication of the presence of an emergency siren. Such a scheme does not overcome the problem of motorist playing loud music.

Generally, conventional schemes may indicate the presence of an emergency siren and the direction of travel of the emergency vehicle sounding the siren at given time. For example, in one prior art scheme the emergency vehicle broadcasts its direction of travel (e.g., “heading North”). Such information is not readily usable by the motorist. It is difficult for a motorist in the few seconds required to respond to discern their own direction of travel. Moreover, because both the emergency vehicle and the motorist's vehicle are typically in motion, the direction of motion of the emergency vehicle relative to the motorist's vehicle may be changing.

All of the prior art schemes have the distinct disadvantage of not providing the motorist information concerning the movement of the emergency vehicle relative to the motorist's vehicle and to specific fixed landmarks such as intersections.

Conventional schemes do not provide the motorist with information that can be used quickly to respond to an emergency vehicle effectively.

### SUMMARY

For one embodiment of the invention, audio information from an emergency vehicle is received at a directional microphone. The position and velocity (speed and direction of motion) of the emergency vehicle are determined based upon the received audio information. The position and velocity of the emergency vehicle is input to a display device and the position and velocity of the emergency vehicle is displayed.

Other features and advantages of embodiments of the present invention will be apparent from the accompanying drawings and from the detailed descriptions that follows below.

### BRIEF DESCRIPTION OF THE DRAWINGS

The invention may be best understood by referring to the following description and accompanying drawings that are used to illustrate embodiments of the invention. In the drawings:

FIG. 1A illustrates a display in accordance with one embodiment of the invention;

FIG. 1B illustrates a display in accordance with one embodiment of the invention;

FIG. 1C illustrates a display in accordance with one embodiment of the invention;

FIG. 1D illustrates a display in accordance with one embodiment of the invention;

FIG. 2 illustrates a process in accordance with one embodiment of the invention; and

FIG. 3 illustrates a functional block diagram of a digital processing system in accordance with one embodiment of the invention.

### DETAILED DESCRIPTION

A method and system for providing a user with information indicating the position and velocity of an emergency vehicle relative to the user and to known landmarks. For one embodiment of the invention, a directional microphone positioned on the exterior of a vehicle is designed to detect siren frequencies of emergency vehicles and provide the operator of the vehicle with information regarding the location, speed, and direction of travel of the emergency vehicle.

For one embodiment of the invention, the user is provided with a display that indicates the user's position and the position and movement of the emergency vehicle. For one Such embodiment, the display includes street names, intersections, traffic directions, and other landmarks in the vicinity of the user's vehicle.

For an alternative embodiment of the invention, upon detection of siren frequencies of emergency vehicles, the audio system of the vehicle is interrupted to allow the vehicle operator to hear the siren. For one such embodiment, if the vehicle operator was listening to the radio, television, or recorded sounds when the siren was detected, such audio content is disabled and an indication of the detection of the siren is communicated through the audio system.

In the following description, numerous specific details are set forth. However, it is understood that embodiments of the invention may be practiced without these specific details. In other instances well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Embodiments of the invention are applicable in a variety of settings in which a user may be approached by an emergency vehicle operating a warning siren.

Typically, sirens used by police or other emergency agencies (e.g., medical, disaster, etc.) produce a sound in the 500 Hz-2.7 KHz range, Such a range is readily discernible by conventional directional microphones as known in the art. For one embodiment of the invention, a vehicle has a directional microphone mounted on an exterior portion of the vehicle. For one such embodiment the input from the directional microphone is output to the user via a visual display that indicates the direction and speed of the emergency vehicle.

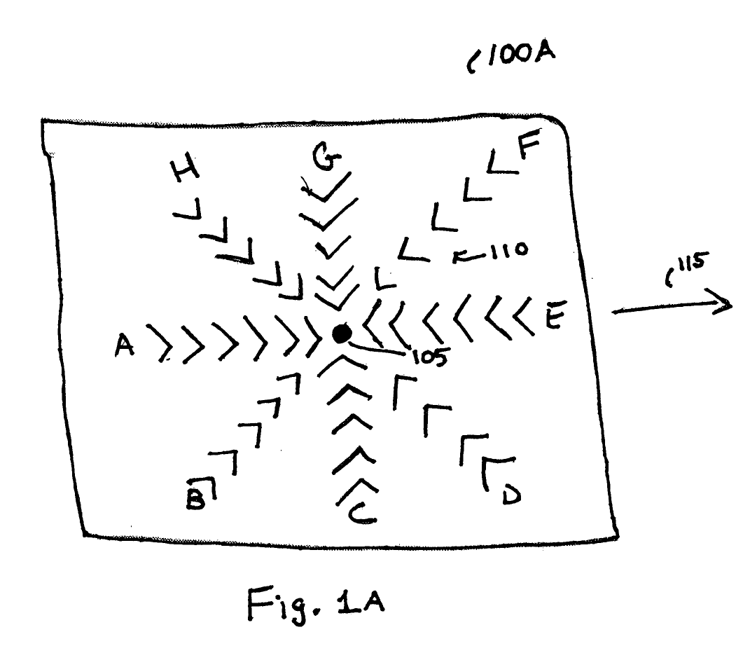

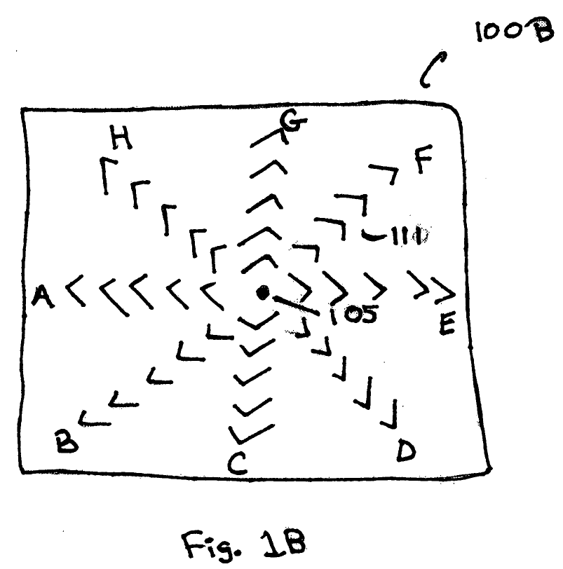

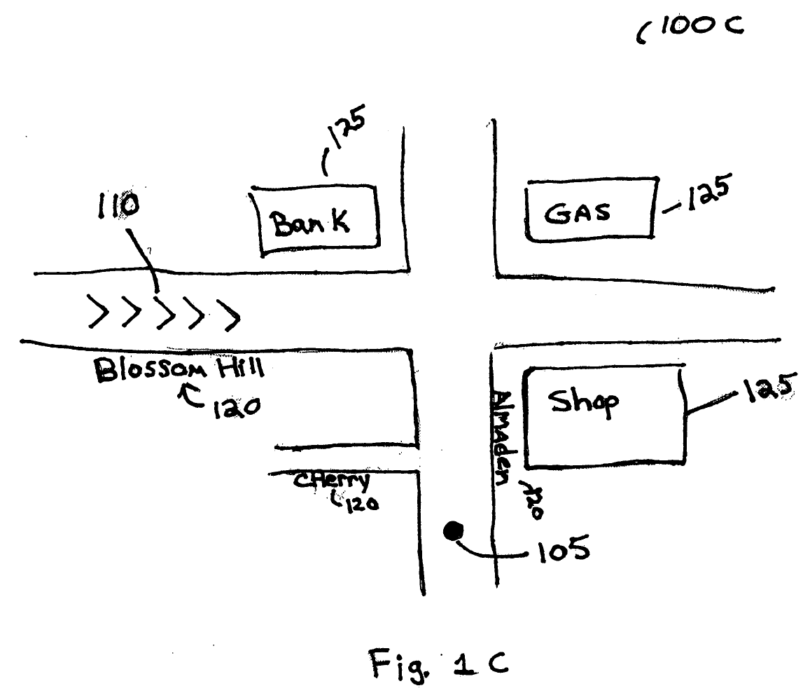

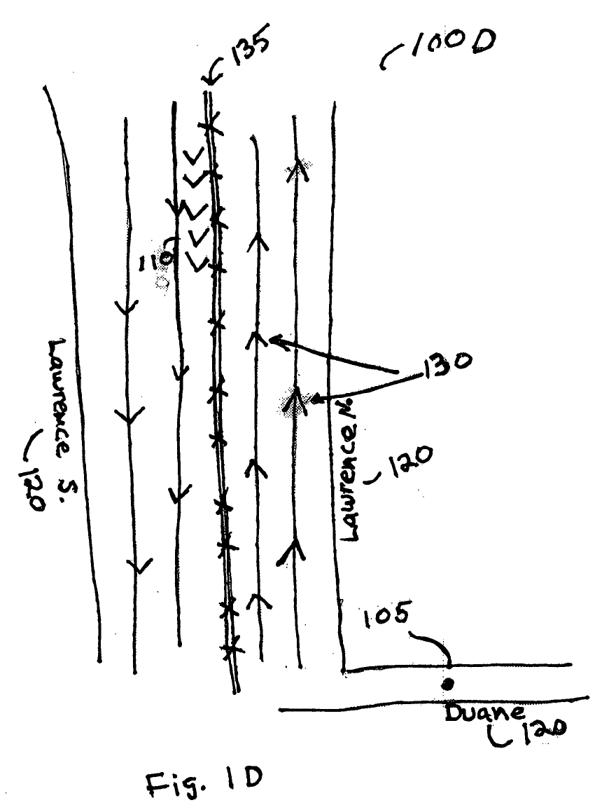

FIG. 1A illustrates a display in accordance with one embodiment of the invention. Display 100A, shown in FIG. 1A, includes a user position indicator 105 that indicates the position of the user (e.g., the user's vehicle). The display 100A also has velocity indicators 110 that indicate the speed and direction of approach of an emergency vehicle. The velocity indicators 110 may be implemented as lights which are illuminated based on the input from the directional microphone. Each column of indicators A-G, may be used discretely to indicate the direction from which the emergency vehicle is approaching the user. Moreover, where the indicators are lights, they may be illuminated in a sequential pattern with a frequency that indicates the speed at which the emergency vehicle is approaching the user.

The position and velocity of the emergency vehicle may be determined repeatedly at regular or irregular intervals to provide updated position and velocity information. As the velocity and position of the emergency vehicle changes relative to the user, the indicator 100A will indicate a new direction of approach and the frequency at which the indicators 10 are illuminated will indicate a change in speed. For example, if the user is oriented in the direction indicated by arrow 115 and the emergency vehicle is approaching the user from the user's left-hand side, the indicators 110 of column G will be illuminated at a frequency that indicates the speed of the emergency vehicle. If the emergency vehicle stops, the indicators may remain illuminated or blink at a very slow rate. If the emergency vehicle changes direction relative to the user, a different column of indicators may be illuminated. For example, if column C represents an intersection which the user is approaching, then the indicators of column F may be illuminated initially. As the user reaches the intersection, then indicators of column C may be illuminated (while those of column F no longer are illuminated). As the user passes the intersection, then indicators of column H may be illuminated (while those of column G no longer are illuminated). Subsequently, if the emergency vehicle makes a left turn at the intersection, then indicators of column A may be illuminated (while those of column H no longer are illuminated).

FIG. 1B illustrates a display in accordance with one embodiment of the invention. Display 100B indicates the situation in which the emergency vehicle is moving away from the user. As shown, velocity indicators 111 are pointing away from the user position indicator 105.

For alternative embodiments of the invention, the display may include a map of the vicinity of the user. The map may include roads, intersections, and other landmarks. Such map displays may be provided via a Global Positioning Satellite (GPS) navigational system as know in the art. For such an embodiment, the display may indicate the road on which the emergency vehicle is traveling as well as the direction and speed of travel. The display may also indicate the direction of traffic for the roads displayed. This will help the user determine if the emergency vehicle will intersect the user's course. For example, the emergency vehicle may be approaching the user, but the emergency vehicle may be on a road which overpasses the road on which the user is traveling. Therefore, the user may not be required to take any action. Alternatively, the user may be traveling on a one-way road in which case the emergency vehicle will most likely not be approaching the user head-on regardless of its indicated course.

FIG. 1C illustrates a display in accordance with one embodiment of the invention. Display 100C includes street names 120 and landmarks 125 which provide the user with more information as to the position and travel direction of the emergency vehicle. The street names 120 and landmarks 125 also provide the user with information as to where it may be possible or preferable to pull-over to avoid interfering with the emergency vehicle.

FIG. 1D illustrates a display in accordance with one embodiment of the invention. Display 100D includes traffic direction indicators 130 and traffic divide indicator 135 to inform the user of the traffic direction for streets in the vicinity of the user. The traffic direction indicators 130 and traffic divide indicator 135 provide the user with more information about the movement of the emergency vehicle. For example, as shown in FIG. 1D, if the user intends to turn right onto Lawrence N., the user need not delay as the user is informed by display 100D that the emergency vehicle is traveling on Lawrence S. which is divided from Lawrence N. by a traffic divide.

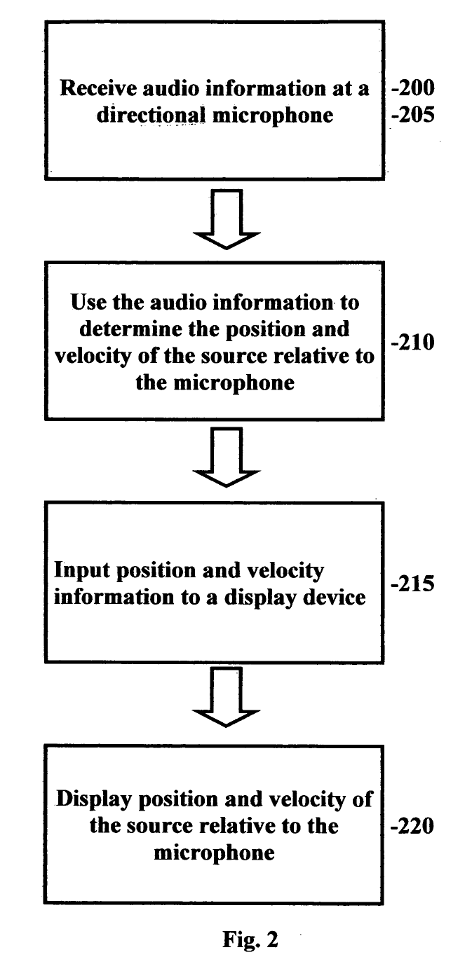

FIG. 2 illustrates a process in accordance with one embodiment of the invention. Process 200, shown in FIG. 2, begins at operation 205 in which audio information is received from an emergency vehicle at directional microphone. For one embodiment of the invention, microphone may be positioned on an external surface of a vehicle. For one embodiment of the invention, the audio information may be an audio signal with a frequency in the range of 500 Hz-2.7 KHz. For one embodiment, such audio information may constitute a siren of the emergency vehicle.

At operation 210 the audio information is used to determine the position and velocity of the emergency vehicle relative to the directional microphone. For one embodiment, the Doppler effect of the audio information is used to determine velocity. For one embodiment, a specified volume of the audio information is used to determine the position of the source of the audio information. For example, the siren of emergency vehicles typically has a specific standard frequency as well as a standard volume. The volume of the received audio information, therefore can be used to determine distance.

At operation 215, the position and velocity of the emergency vehicle relative to the directional microphone is input to a display device capable of conveying the information to a user. For one embodiment the display device may be positioned in the interior of the vehicle on which outer surface the directional microphone is positioned.

At operation 220, the position and velocity of the emergency vehicle relative to the directional microphone is displayed to the user. For one embodiment of the invention, the display may provide visual and audio feedback to the user to convey the velocity and position of the source of the audio information relative to the directional microphone.

The operations of Process 200 may be repeated periodically (e.g., every 2-3 seconds) to provide an updated position and velocity of the emergency vehicle as noted above.

The display in accordance with one embodiment may be part of a navigational system that includes a digital content storage device (e.g., a digital processing system (DPS)). The DPS may be configured to store, process, and communicate a plurality of various types of digital information including stored map data and GPS signals.

As noted above, embodiments of the invention may provide a mechanism for interrupting the audio system of a vehicle upon detection of siren frequencies of emergency vehicles. This allows the vehicle operator to hear the siren. Additionally, the an indication of the detection of the siren is communicated through the audio system.

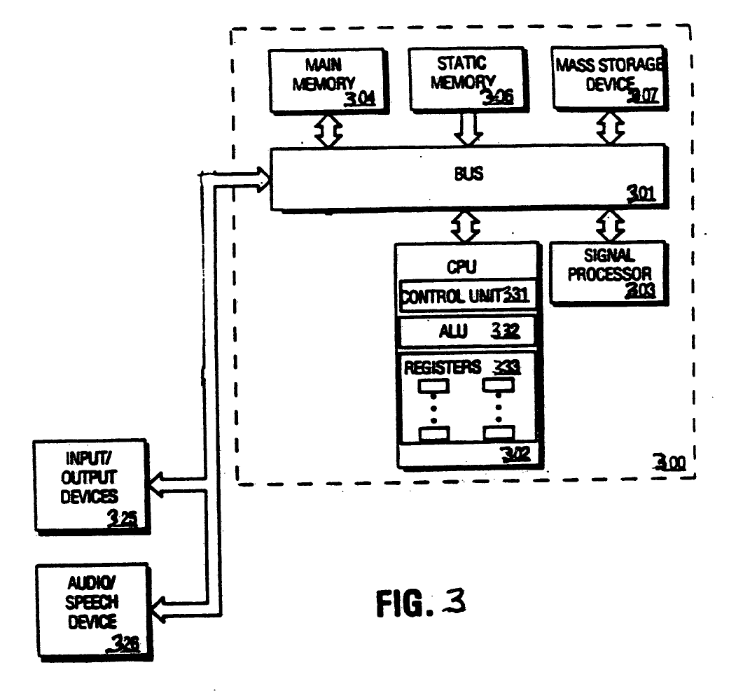

As discussed above, embodiments of the invention may employ a DPS or devices having digital processing capabilities. FIG. 3 illustrates a functional block diagram of a digital processing system in accordance with one embodiment of the invention. The components of processing system 300, shown in FIG. 3 are exemplary in which one or more components may be omitted or added. For example, one or more memory devices may be utilized for processing system 300.

Referring to FIG. 3, processing system 300 includes a central processing unit 302 and a signal processor 303 coupled to a main memory 304, static memory 306, and mass storage device 307 via bus 301. In accordance with an embodiment of the invention, main memory 304 may store a selective communication application, while mass storage devise 307 may store various digital content as discussed above. Processing system 300 may also be coupled to input/output (I/O) devices 325, and audio/speech device 326 via bus 301. Bus 301 is a standard system bus for communicating information and signals. CPU 302 and signal processor 303 are processing units for processing system 300. CPU 302 or signal processor 303 or both nay be used to process information and/or signals for processing system 300. CPU 302 includes a control unit 331, an arithmetic logic unit (ALL) 332, and several registers 333, which are used to process information and signals. Signal processor 303 may also include similar components as CPU 302.

Main memory 304 may be, e.g., a random access memory (RAM) or some other dynamic storage device, for storing information or instructions (program code), which are used by CPU 302 or signal processor 303. Main memory 304 may store temporary variables or other intermediate information during execution of instructions by CPU 302 or signal processor 303. Static memory 306, may be, e.g., a read only memory (ROM) and/or other static storage devices, for storing information or instructions, which may also be used by CPU 302 or signal processor 303. Mass storage device 307 may be, e.g., a hard or floppy disk drive or optical disk drive, for storing information or instructions for processing system 300.

### GENERAL MATTERS

Embodiments of the invention include a system that provides a display of the position and velocity of an emergency vehicle relative to a user's vehicle. Various embodiments have been described. Some embodiments include a display that displays information through a GPS navigational system. For one such embodiment, the emergency vehicle indicator as described in various embodiments if incorporated into such a navigational system.

Embodiments of the invention also provide a mechanism for interrupting the audio system of a vehicle upon detection of siren frequencies of emergency vehicles to allow the vehicle operator to hear the siren. For one such embodiment, if the vehicle operator was listening to the radio, television, or recorded sounds when the siren was detected, such audio content is disabled and an indication of the detection of the siren is communicated through the audio system.

Embodiments of the invention have been described as including various operations. Many of the processes are described in their most basic form, but operations can he added to or deleted from any of the processes without departing from the scope of the invention.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central cite or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving audio information from an emergency vehicle at a directional microphone;
determining the position and velocity of the emergency vehicle based upon the received audio information;
inputting the position and velocity of the emergency vehicle to a display device; and
displaying the position and velocity of the emergency vehicle.

2. The method of claim 1 wherein the audio information is a siren having a frequency within the range of 500 Hz-2.7 KHz.

3. The method of claim 1 further comprising:
repeating the operations of receiving, determining, inputting, and displaying periodically; and
displaying an updated position and an updated velocity of the emergency vehicle.

4. The method of claim 1 wherein the velocity of the emergency vehicle is determined using a Doppler analysis of the received audio information

5. The method of claim 1 wherein the distance of the emergency vehicle is determined based upon the volume of the received audio information.

6. The method of claim 1 further comprising:
interrupting an audio system of a vehicle upon receipt of audio information from an emergency vehicle to allow an operator of the vehicle to hear the audio information.

7. An apparatus comprising:
a directional microphone for receiving audio information from an emergency vehicle;
a digital processing system coupled to the directional microphone for processing the received audio information and determining the position and velocity of the emergency vehicle based upon the received audio information; and
a display device coupled to the digital processing system for displaying the position and velocity of the emergency vehicle.

8. The apparatus of claim 7 wherein the audio information is a siren having a frequency within the range of 500) Hz-2.7 KHz.

9. The apparatus of claim 7 wherein the velocity of the emergency vehicle is determined using a Doppler analysis of the received audio information.

10. The apparatus of claim 7 wherein the distance of the emergency vehicle is determined based upon the volume of the received audio information.

11. The apparatus of claim 7 further comprising:
an audio system interruption mechanism for interrupting an audio system of a vehicle upon receipt of audio information from an emergency vehicle to allow an operator of the vehicle to hear the audio information.

12. A machine-readable medium that provides executable instructions, which when executed by a processor, cause the processor to perform a method, the method comprising:
receiving audio information from an emergency vehicle at a directional microphone;
determining the position and velocity of the emergency vehicle based upon the received audio information;
inputting the position and velocity of the emergency vehicle to a display device; and
displaying the position and velocity of the emergency vehicle.

13. The machine-readable medium of claim 12 wherein the audio information is a siren having a frequency within the range of 500 Hz-2.7 KHz.

14. The machine-readable medium of claim 12 further comprising
repeating the operations of receiving, determining, inputting, and displaying periodically; and
displaying an updated position and an updated velocity of the emergency vehicle.

15. The machine-readable medium of claim 12 wherein the velocity of the emergency vehicle is determined using a Doppler analysis of the received audio information.

16. The machine-readable medium of claim 12 wherein the distance of the emergency vehicle is determined based upon the volume of the received audio information.

17. The machine-readable medium of claim 12 further comprising:
interrupting an audio system of a vehicle upon receipt of audio information from an emergency vehicle to allow an operator of the vehicle to hear the audio information.
